(19) United States
(12) Patent Application Publication
(10) Pub. No.: US 2009/0284732 A1
(43) Pub. Date: Nov. 19, 2009

(54) Apparatus and method of using thermochromic and photochromic indicators

(76) Inventor: Rodney P. Vitale, Redondo Beach, CA (US)

Correspondence Address: BERLINER & ASSOCIATES, 555 WEST FIFTH STREET, 31ST FLOOR, LOS ANGELES, CA, 90013, US

(21) Appl. No.: 11/989,658

(22) PCT Filed: Nov. 23, 2005
(86) PCT No.: PCT/US2005/042781

§ 371 Date: Jan. 29, 2008

Related U.S. Application Data
(60) Provisional application No. 60/707,719, filed on Aug. 12, 2005.

(51) Int. Cl. B65D 79/02; B65D 23/16; B65D 51/24; B65D 23/00; G01J 3/46

(52) U.S. Cl. 356/51; 220/662; 220/377; 206/459.1; 215/365

(57) ABSTRACT

The present is directed to an apparatus and method to monitor water treated with the SODIS process and comprises a container and an indicator element which is either affixed, applied or embedded to the container or the container's cap. The, indicator element comprise of at least one thermochromic indicator and at least one photochromic indicator.

### FIELD OF INVENTION

This invention relates, generally, to an apparatus and method to assess water purity; more particularly an apparatus and method that assess water purity by monitoring changes in UV and thermal absorbances.

### BACKGROUND

Water in sufficient quantity and good quality is essential for life. However, at the beginning of the year 2000 over a billion people were without access to improved water supply and even more people were lacking access to safe potable water. Poor quality drinking water leads to a high risk of water-borne diseases such as diarrhea, cholera, typhoid fever, hepatitis A, amoebic and bacillary dysentery and other diarrhoeal diseases, many of which cause death.

Solar water disinfection (SODIS) is a simple water treatment method using solar radiation (UV-A light and temperature) to destroy pathogenic bacteria and viruses present in the water. Its ability to destroy these organisms is dependent on the water temperature reached during solar exposure and on the climate conditions. At this present time, bacteria and other chemical tests are used to determine whether SODIS treated water is potable. However, such tests are expensive and time consuming, and may not even be necessary because extensive field tests have already been performed on the SODIS process. The results of these field tests show that water purified from the SODIS process is potable only if certain levels of UV intensity and heat are attained during the process. Thermometers are conventionally used to determine water temperature but these are fragile and expensive, and insertion of thermometers into the container will most likely introduce more contamination. Electronic equipment is conventionally used to measure UV radiation but these are expensive to purchase and maintain, particularly in economies of the world which will be relying on the SODIS process.

Thermochromic dyes are substances that have the characteristic of reversibly changing color when exposed to certain levels of temperature. U.S. Patent Application Serial No. 20020097777 has a thermochromatic display printed on the outside wall of a ceramic cup to inform the drinker that the beverage is at a certain temperature. U.S. Pat. No. 6,929,136 also discloses a beverage container cap that is embedded with a thermochromic material which changes color as the temperature of the cap changes, thereby making them more visually discernable to the consumer. Photochromatic compounds are substances which have the characteristic of reversibly changing color and/or degree of light transmission when exposed to certain types of electromagnetic radiations and solar light, returning to their original state of color and transmission when the initial light source is removed. In recent years, photochromic articles, particularly photochromic plastic materials for optical applications, have been the subject of considerable attention. In particular, photochromic ophthalmic plastic lenses have been investigated because of the weight advantage they offer, vis-a-vis, glass lenses (U.S. Pat. No. 6,786,598). Moreover, photochromic transparencies for vehicles, such as cars, boats and airplanes, have been of interest because of the potential safety features, that such transparencies offer (See U.S. Pat. No. 6,536,828). Nevertheless, even though both thermochromic and photochromic materials have been around for many years, there are, at present, no devices that have incorporated either one, or both of them, to monitor the SODIS process.

A well known problem with using plastic containers in the SODIS process is that they deteriorate upon repeated exposure to sunlight. Moreover, such containers also deteriorate because of mechanical scratches that accumulate over time. Such deterioration compromises the ability of the container to transmit UV radiation, and therefore compromises the SODIS process. At present, visual inspection of the containers is used to ascertain container integrity. However, because this assessment is subjective, there is a need for a more objective and quantifiable method.

As employed herein, the term “thermochromic materials” is intended to mean materials that have or exhibit different colors or shades of color at different temperatures. The expression “responding thermochromically” as used herein is intended to mean having or exhibiting different colors or shades of color at different temperatures. The expression “photochromic materials” as used herein is intended to mean materials that have or exhibit different colors or shades of color at different UV intensities. The expression “responding photochromically” as used herein is intended to mean having or exhibiting different colors or shades of color at different UV intensities.

The terms thermochromic/photochromic inks, dyes and pigments are used interchangeably herein. The term ‘potability’ as employed herein is intended to mean the drinkable quality of water.

In light of the foregoing, there is a need to provide an apparatus that people using the SODIS process can adopt to determine whether the processed water is potable, and to determine whether the container's integrity is intact. Moreover, there is a need for an apparatus to be used in the SODIS process that is inexpensive, easy to maintain, and easy to use.

### SUMMARY OF THE INVENTION

This invention is directed towards overcoming the above shortcomings by disclosing an apparatus and method that is cost effective, portable and easy to use to monitor the SODIS water purification process.

In one embodiment, the apparatus in accord with the invention comprises a container having an opening through which a liquid in the container can be dispensed from the container, a cap adapted to be removably secured to said container to cover said opening, an indicator element being in the form of a strip, where the strip conforms to the contour of the outside surface of the outside wall of the container, and the indicator element comprises at least one thermochromic indicator and at least one photochromic indicator.

In another embodiment, the apparatus according to the invention comprises a container having an opening through which a liquid in the container can be dispensed from the container, a cap adapted to be removably secured to the container to cover the opening, an indicator element being in the form of a strip affixed to the outer surface of the cap, where the strip conforms to the contour of the outside surface of the cap, and where the indicator element comprises at least one thermochromic indicator and at least one photochromic indicator.

In another aspect of the invention, the apparatus comprises a container having an opening through which a liquid in the container can be dispensed from the container, a cap adapted to be removably secured to the container to cover the opening, and an indicator element applied onto the surface of the container, where the indicator element comprises at least one thermochromic dye and at least one photochromic dye.

In yet another aspect of the invention, the apparatus comprises a container having an opening through which a liquid in the container can be dispensed from the container, a cap adapted to be removably secured to the container to cover the opening, and an indicator element applied onto the surface of the cap, where the indicator element comprises at least one thermochromic dye and at least one photochromic dye.

In another construction, the apparatus has a container having an opening through which a liquid in the container can be dispensed from the container, a cap adapted to be removably secured to the container to cover the opening, and an indicator element embedded into the surface of the container, where the indicator element comprises at least one thermochromic dye and at least one photochromic dye.

In yet another construction of the invention, the apparatus is a container having an opening through which a liquid in the container can be dispensed from the container, a cap adapted to be removably secured to the container to cover said opening, and an indicator element embedded into the surface of the cap, where the indicator element comprises at least one thermochromic dye and at least one photochromic dye.

In one embodiment of the invention, the apparatus is a container a container having an opening through which a liquid in the container can be dispensed from the container, a cap adapted to be removably secured to the container to cover said opening, an elongated element that is inserted into the container, and an indicator element applied to the elongated element, where the indicator element is comprises at least one thermochromic dye and at least one photochromic dye.

In another embodiment of the invention, the apparatus is a container a container having an opening through which a liquid in the container can be dispensed from the container, a cap adapted to be removably secured to the container to cover said opening, an elongated element that is inserted into the container, and an indicator element embedded into the elongated element, where the indicator element is comprises at least one thermochromic dye and at least one photochromic dye.

In one construction of the invention, the apparatus is used to determine the potability of water, comprising pouring liquid into a container, where the container comprises an indicator, where the indicator comprises at least one thermochromic material, and at least one photochromic material, closing said cap on said container, exposing said container to a UV source, and discerning visually a color change in said indicator.

In yet another construction of the invention, the apparatus is used to determine the integrity of a container exposed to UV radiation comprising pouring liquid into a container, pouring liquid into a container, where the container comprises an indicator element, where the indicator comprises at least one thermochromic material and at least one photochromic material, closing the cap on said container, exposing the container to a UV and thermal source, and discerning visually a color change in said indicator.

In yet another construction of the invention, the apparatus is used to determine the integrity of a container exposed to UV radiation comprising pouring liquid into a container, placing a elongated element into the container, where the element comprises an indicator, and where the indicator comprises at least one thermochromic material and at least one photochromic material, closing said cap on said container, exposing said container to a UV source, discerning visually a color change in said indicator, and comparing the color change to the color change obtained using a control container.

An advantage of the invention is that the invention is cost effective, portable, and easy to use.

The foregoing, and other features and advantages of the invention, will be apparent from the following, more particular description of the preferred embodiments of the invention, the accompanying drawings, and the claims.

### BRIEF DESCRIPTION OF THE DRAWINGS

FIG. 1 is a front view of a first embodiment of the indicator strip in keeping with the present invention, when intimately affixed to the outside surface of the outside wall of a container.

FIG. 2 is a plan view of the thermochromic and photochromic arrays of the first embodiment of the indicator.

FIG. 3 is a perspective view of the indicator display of the first embodiment intimately affixed to the cap of the container.

FIG. 4 is a front view showing an elongated element comprising of the indicator when inserted into a container.

FIG. 5 depicts a sample calculation matrix.

FIG. 6 is a view of one embodiment of the invention being used to monitor the potability of water.

Further objects, features, and advantages of the invention will become apparent from the following detailed description taken in conjunction with the accompanying figures showing a preferred embodiment of the invention.

### DETAILED DESCRIPTION OF THE DRAWINGS

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of the embodiments of the invention.

The invention as disclosed can be used to monitor the quality of water purified using the Solar Water Disinfection (SODIS) process. In this process, contaminated water is filled into transparent plastic bottles and exposed to full sunlight. During this time, sunlight destroys the pathogenic microorganisms present in the contaminated water through two synergetic mechanisms: radiation in the UV-A spectrum (wavelength 320 nm-400 nm) and increased water temperature. If the water temperature reaches above 50 degrees Celsius, the disinfection process is three times faster.

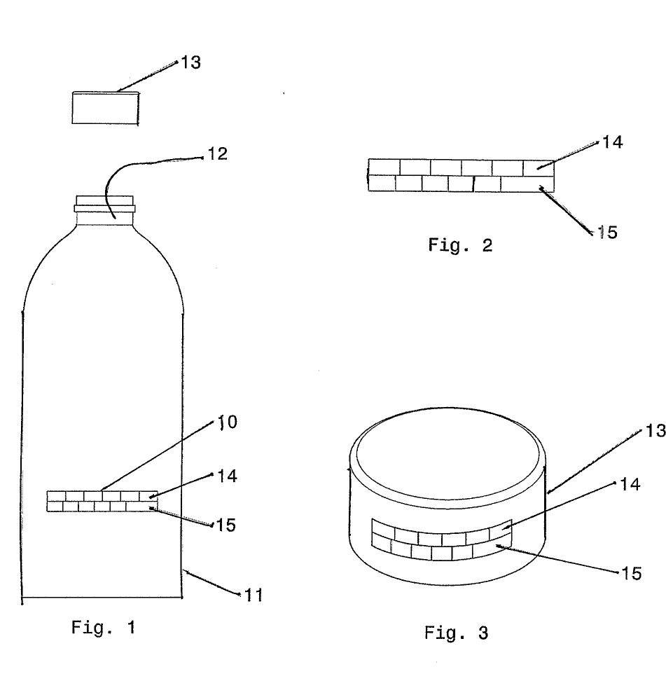

Turning now to the figures in which one presently preferred embodiment of the invention appears, FIG. 1 shows a perspective view of an indicator strip 10 intimately affixed to a container 11. The container has an opening 12 through which a liquid in the container can be dispensed from the container. There is also shown a cap 13 adapted to be removably secured to the container opening. The indicator strip comprises two separate arrays—the thermochromic 14 and photochromic 15 arrays. FIG. 3 shows that the indicator strip can also be secured onto the surface of the container's cap. In this embodiment the indicator label could be manufactured and sold separately to be adhesively applied by a user to his or her existing bottle. It is understood however that the indicator strip could come already affixed and sold with the bottle.

The container 11 in FIG. 1 as exemplified here is a beverage water container. However it is understood that it can be any suitable container capable of storing liquid. The container is made of transparent material capable of transmitting light in the UV and visible range of the solar spectrum. Plastic containers made from PET (PolyEthylene Terephtale) are preferred because they contain less UV-stabilizers than PVC (PolyVinylChloride) containers. Alternatively, the containers could be made of glass. Preferably, containers are shaped to expose a large area per water volume, for instance like those used to culture microorganisms and cells. Such containers allow the water to be more efficiently treated by the SODIS process. The cap 13 can be made of PET, PVC or other materials known in the art to make bottle caps.

Referring now to FIG. 2 where an indicator strip is illustrated. In this embodiment, the thermochromic indicator array 14 is positioned above the photochromic indicator array 15. However, it will be recognized that the photochromic indicator array could be positioned above the thermochromic indicator array; or alternatively, the two arrays could lie end to end.

Turning to the thermochromic array, an individual segment is activated when the container attains a certain temperature. Each temperature marker is a different thermochromic pigment. As the temperature rises above the marker the segment color will fade to a lighter color or become transparent, and then reverse back to the darker color again when the temperature cools down. In the preferred embodiment the thermochromic array 14 is broken into six segments: 29, 35, 40, 45, 50 and 55 degrees centigrade, as these temperatures support the SODIS process. However, it is understood that other temperature segments are possible depending upon the availability of specific thermochromic pigments. Thermochromic pigments are available from companies such as H.W. Sands Corp (Jupiter, Fla.). Thermochromic colors can include, but are not limited to, Fast Yellow, Gold Orange, Vermillion, Brilliant Rose, Pink, Magenta, Fast Blue, Artic Blue, Brilliant Green, Fast Black, Green, Brown and the like. Mixtures of pigments and colors are also possible.

In the preferred embodiment, the bottom section of the indicator is the photochromic color gage 15 wherein five segments are illustrated: >30%, >40%, >50%, >60%, 100% and a blank segment (See FIG. 2). The five segments are color shaded. The blank square contains the photochromic pigment. As this last square is exposed to UV radiation, the color will change from white to a different color shade. The higher the UV intensity the darker the color shade. The color shade on the last segment is then compared with the color shades on each of the five segments. The preferred range is between 30% to 100% UV intensity because this range supports the SODIS process. It is understood, that instead of >30%, and 100%, words such as, but not limited to, “impure” and “ready” could be used. Photochromic indicator strips such as those described are available from companies such as Chromatic Technologies, Inc., Colorado Springs, Colo.

In a second embodiment of the invention, photochromic and thermochromic pigments are sprayed, coated, or printed onto the surface of the container. The terms, thermochromic inks, dyes and pigments are used interchangeably herein. Preferable thermochromic dyes, such as microencapsulated three-component mixtures of an acid developing substance, an acidic substance and a solvent, are described in U.S. Pat. No. 6,929,136; U.S. Pat. No. 5,221,288 and U.S. Pat. No. 4,957,949, the entire contents of which are hereby incorporated by reference. Alternatively, appropriate thermochromic dyes can be dispersed into suitable resins such as unmodified epoxies PVC, ABS, or coatings that may be formed by dispersing the dyes into varnishes and coatings, such as polyurethane clear coatings as described in U.S. Pat. No. 6,773,637, the entire content of which is hereby incorporated by reference. Photochromic polymeric coating materials and the methods used to coat plastics are described U.S. Pat. No. 6,733,887, the entire contents of which are hereby incorporated by reference.

Embodiments one, and two (and four below) of this invention can be used to determine the potability of water after treatment by the SODIS process. To do this, the container is placed with the indicator strip/coat facing up thereby directly exposing the indicator to the sun's radiation. A user will then note the readings on both the thermochromic and photochromic indicator strips. A certain reading on both indicators will then signify to the user that the water is sufficiently potable.

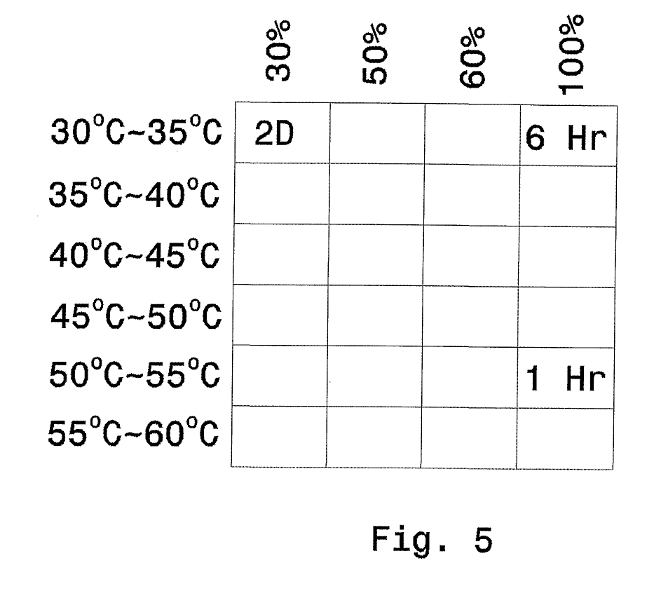

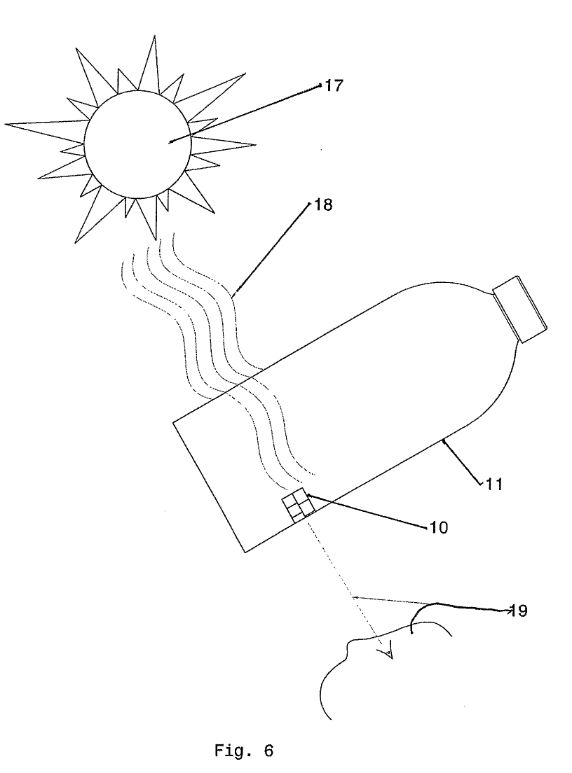

FIG. 6 shows how embodiments one and two of this invention can also be used to determine the integrity of containers used for the SODIS process. The container 11 can be placed with the indicator strip/coat 10 facing down and exposing the container to the sun's 17 radiation 18. A user 19 will then note readings on the photochromic array can then be compared to readings obtained using ‘control’ containers (i.e., new containers). A reading at variance with those obtained from the controls will indicate that the integrity of the container has been compromised. As containers become less effective in UV transmission, the time required for purification becomes extended from hours using uncompromised containers to two days with compromised containers. FIG. 5 shows the relationships of time of exposure to the sun, percentage UV irradiation intensity, and temperature in the SODIS process. Such an objective assessment of container integrity could save considerable costs resulting from the premature replacement of otherwise SODIS-effective containers.

In a third embodiment of the invention, photochromic and thermochromic pigments are embedded into the plastic of the container or cap prior to the plastic being formed into a bottle or cap configuration. Preferable methods include one or more of injection molding, extrusion, and compression molding. Preferably, the pigment can be incorporated as a master batch directly in the extruder, or mixed manually (if pelleted, for example) with the container/cap material in advance, and details of which are described in U.S. Pat. No. 6,929,136, the entire content of which is hereby incorporated by reference. Alternatively, thermochromic dyes such as polythiophenes can be used as described in U.S. Pat. No. 6,706,218, the entire content of which is hereby incorporated by reference. With regards to photochromic dyes, the type of dye and methods used to incorporate them into the plastic is described in U.S. Pat. No. 6,555,028 the entire content of which is hereby incorporated by reference.

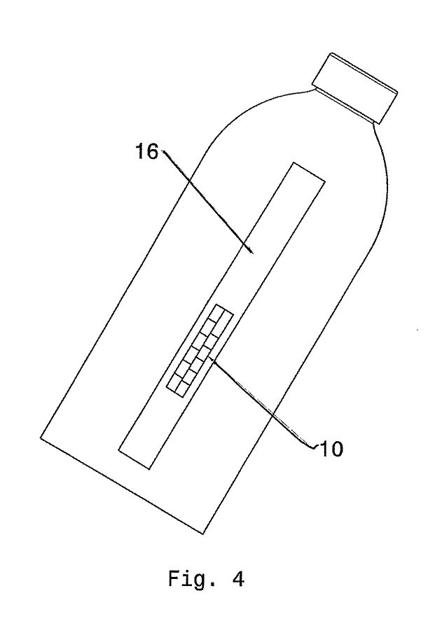

In a fourth embodiment of the invention (see FIG. 4), the photochromic and thermochromic pigments are affixed, sprayed or embedded into an elongated element 16 such as, but not limited to, an elongated rounded rod or an elongated flatten object, like a ruler. The materials for this elongated element can be, but not limited to, wood, plastic, metal and glass. The dyes and methods used for this embodiment are similar to those discussed above.

It should be understood that the invention has application far beyond the exemplary embodiments presented and described herein, and as such is not to be limited to those embodiments. In addition, the invention is not limited to the particularly physical configuration, but is instead adaptable. All changes, modifications, variations, and other uses and applications which do not depart from the spirit and scope of the invention are deemed to be covered by the invention.

1. A container, for holding liquid, with a body, an opening and a closure for said opening further comprising: an indicator element, which is connected with said body of container or with said closure for said opening, wherein said indicator element comprises at least one thermochromic indicator and at least one photochromic indicator.

2. The container of claim 1, wherein the liquid is water.

3. The container of claim 2, wherein the container is made of plastic.

4. The container of claim 3, wherein the plastic is selected from the group consisting of PET (PolyEthylene Terephtale) and PVC (PolyVinylChloride).

5. The container of claim 4, wherein the thermochromic indicator has a range of 20-100 degrees centigrade.

6. The container of claim 5, wherein the thermochromic indicator has a range of 29-55 degrees centigrade.

7. The container of claim 6, wherein the photochromic indicator has a range of 30%-100%.

8. The container of claim 7, wherein said indicator element is printed on a strip, wherein the strip is affixed to and conforms to the contour of the outside surface of the outside wall of said container or of said closure for said opening.

9. (canceled)

10. The container of claim 7, wherein said indicator element is applied onto the outer surface of said container or of said closure for said opening.

11. (canceled)

12. The container of claim 7, wherein said indicator element is embedded into the surface of the container or of said closure for said opening.

13. (canceled)

14. The container of claim 7, wherein said indicator element is printed onto a strip, wherein said strip is affixed to an elongated element to be inserted into said container.

15. The container of claim 7, wherein said indicator element is either sprayed onto or embedded into an elongated element to be inserted into said container.

16. (canceled)

17. The article of claim 8, wherein said thermochromic indicator is positioned on one portion of said strip, and said photochromic indicator is positioned on another portion of said strip.

18. (canceled)

19. The container of claim 10, wherein said indicator element is applied onto the outer surface of the container or said closure using a method selected from a group consisting of spraying, coating, and printing.

20. (canceled)

21. The container of claim 12, wherein said indicator element is embedded into the surface of the container or said closure using a method selected from a group consisting of injection molding, extrusion, and compression molding.

22. (canceled)

23. The article of claim 14, wherein said elongated element is made of a material selected from the group consisting of wood, plastic, metal and glass.

24. The article of claim 15, wherein said elongated element is made of a material selected from the group consisting of wood, plastic, metal and glass.

25. (canceled)

26. A container, for holding liquid, with a body, an opening and a closure for said opening further comprising: an indicator element, wherein said indicator element is printed on a strip, and wherein the strip is affixed to and conforms to the contour of the outside surface of the outside wall of said container or of said closure for said opening, wherein said indicator element comprises at least one thermochromic indicator and at least one photochromic indicator, wherein the thermochromic indicator has a range of 29-55 degrees centigrade, wherein the thermochromic indicator has a range of 20-100 degrees centigrade, wherein said thermochromic indicator is positioned on one portion of said strip, and said photochromic indicator is positioned on another portion of said strip, wherein the liquid is water, and wherein the container is made of PET.

27. (canceled)

28. A container, for holding liquid, with a body, an opening and a closure for said opening further comprising: an indicator element, wherein said indicator element is applied onto the outer surface of said container or of said closure, wherein said indicator element comprises at least one thermochromic indicator and at least one photochromic indicator, wherein the thermochromic indicator has a range of 29-55 degrees centigrade, wherein the thermochromic indicator has a range of 20-100 degrees centigrade, wherein the liquid is water, and wherein the container is made of

29. (canceled)

30. A container, for holding liquid, with a body, an opening and a closure for said opening further comprising: an indicator element, wherein said indicator element is embedded into the outer surface of said container or of said closure, wherein said indicator element comprises at least one thermochromic indicator and at least one photochromic indicator, wherein the thermochromic indicator has a range of 29-55 degrees centigrade, wherein the thermochromic indicator has a range of 20-100 degrees centigrade, wherein the liquid is water, and wherein the container is made of PET.

31. (canceled)

32. A container, for holding liquid, with a body, an opening and a closure for said opening further comprising: an indicator element, wherein said indicator element is printed onto a strip, wherein said strip is affixed to an elongated element to be inserted into said container, wherein said indicator element comprises at least one thermochromic indicator and at least one photochromic indicator, wherein the thermochromic indicator has a range of 29-55 degrees centigrade, wherein the thermochromic indicator has a range of 20-100 degrees centigrade, wherein said elongated element is made of a material selected from the group consisting of wood, plastic, metal and glass, wherein the liquid is water, and wherein the container is made of PET.

33. A container, for holding liquid, with a body, an opening and a closure for said opening further comprising: an indicator element, wherein said indicator element is either sprayed onto or embedded into onto an elongated element to be inserted into said container, wherein said indicator element comprises at least one thermochromic indicator and at least one photochromic indicator, wherein the thermochromic indicator has a range of 29-55 degrees centigrade, wherein the thermochromic indicator has a range of 20-100 degrees centigrade, wherein said elongated element is made of a material selected from the group consisting of wood, plastic, metal and glass, wherein the liquid is water, and wherein the container is made of PET.

34. (canceled)

35. A method to determine the potability of water using the container of claim 26, comprising:
(i) pouring liquid into a container, (ii) closing said closure for said opening, (iii) placing said container so that indicator element is directly facing and exposed to a UV and thermal source; (iv) exposing said container to said UV and thermal source, and (v) discerning visually a color change in said indicator.

36. A method to determine the potability of water using the container of claim 28, comprising:
(i) pouring liquid into a container, (ii) closing said closure for said opening, (iii) placing said container so that indicator element is directly facing and exposed to a UV and thermal source; (iv) exposing said container to said UV and thermal source, and (v) discerning visually a color change in said indicator.

37. A method to determine the potability of water using the container of claim 30, comprising:
(i) pouring liquid into a container, (ii) closing said closure for said opening, (iii) placing said container so that indicator element is directly facing and exposed to a UV and thermal source; (iv) exposing said container to said UV and thermal source, and (v) discerning visually a color change in said indicator.

38. A method to determine the integrity of container to a UV radiation source using the container of claim 26, comprising:
(i) pouring liquid into a container, (ii) closing said closure for said opening, (iii) placing said container so that indicator element is facing down so that said radiation is transmitted through container before reaching the indicator element, (iv) exposing said container to a UV and thermal source, (v) discerning visually a color change in said indicator. and (vi) comparing the color change to the color change obtained using a control container.

39. A method to determine the integrity of container to a UV radiation source using the container of claim 28, comprising:
(i) pouring liquid into a container, (ii) closing said closure for said opening, (iii) placing said container so that indicator element is facing down so that said radiation is transmitted through container before reaching the indicator element, (iv) exposing said container to a UV and thermal source, (v) discerning visually a color change in said indicator, and (vi) comparing the color change to the color change obtained using a control container.

40. A method to determine the integrity of container to a UV radiation source using the container of claim 30, comprising:
(i) pouring liquid into a container, (ii) closing said closure for said opening, (iii) placing said container so that indicator element is facing down so that said radiation is transmitted through container before reaching the indicator element, (iv) exposing said container to a UV and thermal source, (v) discerning visually a color change in said indicator, and (vi) comparing the color change to the color change obtained using a control container.
